(19) United States
(12) Patent Application Publication
(10) Pub. No.: US 2025/0348750 A1
(43) Pub. Date: Nov. 13, 2025

(54) REINFORCEMENT LEARNING MODEL TRAINING METHODS AND APPARATUSES

(71) Applicant: Alipay (Hangzhou) Information Technology Co., Ltd., Hangzhou (CN)

(72) Inventors: Xudong Han, Hangzhou (CN); Rui Zhang, Hangzhou (CN); Zhen Li, Hangzhou (CN); Jian Sha, Hangzhou (CN); Junping Zhao, Hangzhou (CN)

(73) Assignee: Alipay (Hangzhou) Information Technology Co., Ltd., Hangzhou (CN)

(21) Appl. No.: 18/939,090

(22) Filed: Nov. 6, 2024

(30) Foreign Application Priority Data
May 7, 2024 (CN) 202410559576.5

(51) Int. Cl. G06N 3/092

(52) U.S. Cl. CPC G06N 3/092

(57) ABSTRACT

Methods, computer-readable media, and apparatuses relate to a reinforcement learning model training are described. An example model training system includes at least one training process and at least one inference process. An example method includes: in an inference process, obtaining a latest model weight, updating a weight value of a reinforcement learning model; generating response data based on input data by using an updated reinforcement learning model, forming a training sample based on the input data and the response data, and storing the training sample in a target storage area; and in a training process, obtaining the training sample from the target storage area; updating a weight value of the reinforcement learning model based on the training sample, and sending an updated model weight to the inference process.

### CROSS-REFERENCE TO RELATED APPLICATIONS

This application claims priority to Chinese Patent Application No. 202410559576.5, filed on May 7, 2024, which is hereby incorporated by reference in its entirety.

### TECHNICAL FIELD

One or more embodiments of this specification relate to the artificial intelligence field, and in particular, to a reinforcement learning model training method and apparatus.

### BACKGROUND

Reinforcement learning (Reinforcement Learning) is an important branch of machine learning, and is a computing method in which a machine (also referred to as an intelligent agent or an Agent, Agent) implements a goal through interaction with an environment (Environment). A round of interaction between the machine and the environment means that the machine makes an action (Action) decision in a state (State) of the environment and applies the action to the environment. The environment correspondingly changes and delivers a corresponding reward (Reward) feedback and a next round of state back to the machine. In an interaction process between the intelligent agent and the environment, the intelligent agent learns of a policy of using the best action through obtaining a feedback.

Because a training process of a reinforcement learning model is relatively complex, training efficiency of the reinforcement learning model is not ideal. An improved solution is needed to improve the training efficiency of the reinforcement learning model.

### SUMMARY

One or more embodiments of this specification describe a reinforcement learning model training method and apparatus to improve overall training efficiency of a reinforcement learning model.

According to a first aspect, a reinforcement learning model training method is provided. The method is applied to a model training system. The model training system includes at least one training process and at least one inference process. The method includes: obtaining, by any inference process, a latest model weight, and updating a weight value of the reinforcement learning model; and generating response data based on input data by using an updated reinforcement learning model, forming a training sample based on the input data and the response data, and storing the training sample in a target storage area; and obtaining, by any training process, the training sample from the target storage area; and updating a weight value of the reinforcement learning model based on the training sample, and sending an updated model weight to each inference process.

In a possible implementation, the reinforcement learning model is a human feedback reinforcement learning model including an action model and an evaluation model, the input data is a prompt word, and the generating response data based on input data by using an updated reinforcement learning model, and forming a training sample based on the input data and the response data includes: generating the response data based on the prompt word by using an updated action model; processing a spliced sequence of the prompt word and the response data by using the evaluation model, to generate an evaluation value; and generating a proximal policy optimization PPO sample as the training sample, where the PPO sample includes at least the spliced sequence and the evaluation value.

In a possible implementation, one or more inference acceleration solutions for accelerating a forward propagation process for inference are configured in the inference process.

In a possible implementation, the inference acceleration solution includes at least paged attention, continuous batching, and operator fusion.

In a possible implementation, a ratio between a quantity of inference processes and a quantity of training processes in the model training system is determined in the following manner: determining a first quantity of training samples generated by a single inference process in a unit time; determining a second quantity of training samples used by the single training process in the unit time; and determining a first ratio between the second quantity and the first quantity as the ratio between the quantity of inference processes and the quantity of training processes.

In a possible implementation, the target storage area is implemented as a message queue.

In a possible implementation, the sending an updated model weight to each inference process includes: determining some target weight values that change after the reinforcement learning model is updated, and sending the target weight values to each inference process.

In a possible implementation, the at least one training process includes a first training process that is allocated to a first display memory in a first GPU, the at least one inference process includes a first inference process that is allocated to a second display memory in a second GPU, the first display memory and the second display memory register with network hardware, and the sending an updated model weight to each inference process includes: sending a first command to the network hardware, where the first command includes a target memory address in the second display memory so that the network hardware sends the updated model weight stored in the first display memory to the second display memory to overwrite an existing model weight at the target memory address.

In a possible implementation, the updated model weight is stored in a continuous area in the first display memory; and the sending a first command to the network hardware includes: sending the single first command, where the target memory address is an address corresponding to the continuous area.

In a possible implementation, the at least one training process is a plurality of training processes, and the obtaining, by any inference process, a latest model weight, and updating a weight value of the reinforcement learning model includes: receiving, by the any inference process, a plurality of latest model weights from the plurality of training processes, performing weight fusion on the plurality of weights, and updating the weight value of the reinforcement learning model based on a fused weight.

According to a second aspect, a reinforcement learning model training apparatus is provided. The apparatus is deployed in a model training system. The model training system includes at least one training process and at least one inference process. The apparatus includes: an inference unit, configured to: obtain, by using any inference process, a latest model weight, and update a weight value of a reinforcement learning model; and generate response data based on input data by using an updated reinforcement learning model, form a training sample based on the input data and the response data, and store the training sample in a target storage area; and a training unit, configured to: obtain, by using any training process, the training sample from the target storage area; and update a weight value of the reinforcement learning model based on the training sample, and send an updated model weight to each inference process.

In a possible implementation, one or more inference acceleration solutions for accelerating a forward propagation process for inference are configured in the inference unit.

According to a third aspect, a computer-readable storage medium is provided. The computer-readable storage medium stores a computer program, and when the computer program is executed in a computer, the computer is enabled to perform the method of the first aspect.

According to a fourth aspect, a computing device is provided, including a memory and a processor. The memory stores executable code, and when the processor executes the executable code, the method according to the first aspect is implemented.

Embodiments of this specification provide a reinforcement learning model training method and apparatus. An inference process and a training process of reinforcement learning are decoupled. A basic requirement of an algorithm is satisfied in a weight synchronization manner so that the inference process and the training process after decoupling can be executed in parallel. In addition, a plurality of optimization policies are applied to an inference end, thereby improving a sample generating rate and saving a GPU resource.

### BRIEF DESCRIPTION OF DRAWINGS

To describe the technical solutions of a plurality of embodiments disclosed in this specification more clearly, the following briefly describes the accompanying drawings used for describing embodiments. Clearly, the accompanying drawings in the following description are merely the plurality of embodiments disclosed in this specification, and a person of ordinary skill in the art can still derive other drawings from these accompanying drawings without creative efforts.

FIG. 1 is a schematic diagram illustrating a reinforcement learning procedure, according to a related technology;

FIG. 2 is a schematic diagram illustrating an implementation scenario of a reinforcement learning model training method, according to an embodiment;

FIG. 3 is a flowchart illustrating a reinforcement learning model training method, according to an embodiment; and

FIG. 4 is a schematic block diagram illustrating a reinforcement learning model training apparatus, according to an embodiment.

### DESCRIPTION OF EMBODIMENTS

The following describes solutions provided in this specification with reference to the accompanying drawings.

In a reinforcement learning process, an inference process and a training process are often included. In the inference process, an intelligent agent interacts with an environment based on a current parameter of the intelligent agent to obtain a reward, and generates a corresponding training sample. In the training process, a trainable parameter in the intelligent agent is updated by using the training sample. In a related solution, the training process and the inference process of reinforcement learning are generally performed alternately by the same device (process).

FIG. 1 is a schematic diagram illustrating a reinforcement learning procedure, according to a related technology. As shown in FIG. 1, in some related technologies, a reinforcement learning process is started, and a parameter and training data of a reinforcement learning model are loaded. An inference process and a training process are alternately executed in the same reinforcement learning process. From the beginning, a mode of the reinforcement learning process can be “inference”. The inference process is executed. After the inference process generates some training samples based on a loaded reinforcement learning model, the entire reinforcement learning process switches the mode to “training” and then starts to execute the training process. The training process trains the reinforcement learning model based on the training samples generated during inference, and updates the parameter in the reinforcement learning model. Then, the reinforcement learning process again switches the mode to “inference” and starts a new round of inference process. The inference process and the training process are alternately executed to train the reinforcement learning model. However, the inference process and the training process are alternately executed by using the same process. It is difficult to apply an optimization policy. As a result, a sample generating rate is low, a resource is wasted, and efficiency is not ideal.

Reinforcement learning from human feedback (Reinforcement Learning from Human Feedback, RLHF) is used as an example for description. RLHF is a machine learning method that combines reinforcement learning and human feedback, and is used to train a large language model (Large Language Model, LLM) so that the large language model generates useful and meaningful output for humans. Through human guidance and feedback, the intelligent agent is guided to learn a more complex or ambiguous task, or a task that is difficult for directly obtaining a reward function through encoding. RLHF includes two models: an action model (Actor Model) and an evaluation model (Critic Model), respectively. The action model is the large language model to be trained, and is used to generate a replay (response) or a response based on a given prompt word (prompt) and context. The evaluation model is used to evaluate quality of the reply generated by the action model, and give a corresponding evaluation value. In RLHF, the inference process collects a prompt word and an evaluation value, and generates a corresponding training sample, through running the action model and the evaluation model. The action model and the evaluation model are trained in the training process by using the training sample. In the training process, a proximal policy optimization (Proximal Policy Optimization, PPO) algorithm is used, and a corresponding training sample can also be referred to as a PPO sample.

Through analysis and tests by the inventors, it can be seen that in an RLHF procedure, a time ratio of the inference process to the training process can reach 8:2. In other words, the inference process accounts for most time of whole RLHF. If a speed of generating a sample in the inference process can be improved, a time consumed in whole RLHF can be shortened, thereby improving overall efficiency. However, it can be seen from the above-mentioned description that the inference process and the training process in the related technologies are in the same process and use the same model architecture and inference paradigm. Some acceleration solutions that can improve the inference efficiency in the inference process are specifically designed for the inference process and cannot be used in the training process. In this case, these acceleration solutions cannot be used in an existing RLHF procedure.

On this basis, in embodiments of this specification, the inference process and the training process of reinforcement learning are decoupled. A set of model parameters are locally loaded by using different processes to separately execute the inference process and the training process. These processes are referred to as an inference process and a training process. In addition, a sample and a model parameter are exchanged between the inference process and the training process to satisfy a requirement of an algorithm. Through decoupling the inference process and the training process, the inference process and the training process can run in parallel, thereby improving overall reinforcement learning efficiency. In addition, a specifically designed acceleration solution can be used in each of the inference process and the training process to accelerate speeds of executing the two processes.

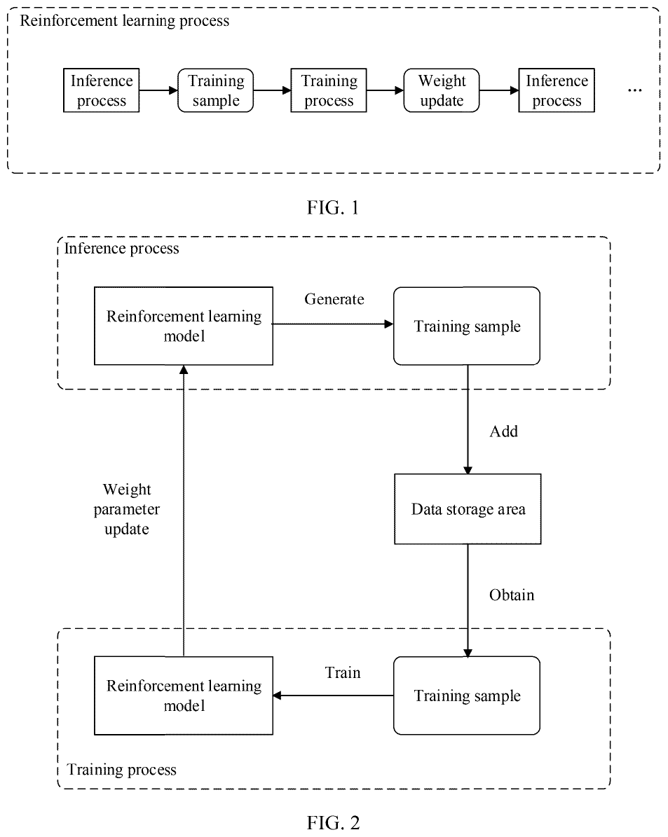

FIG. 2 is a schematic diagram illustrating an implementation scenario of a reinforcement learning model training method, according to an embodiment. As shown in FIG. 2, a reinforcement learning model training system in this embodiment of this specification includes at least one inference process and one training process. The training process and the inference process each have independent GPU (Graphics Processing Unit, graphics processing unit) display memory space, and each load an initial reinforcement learning model architecture and a parameter to the display memory space. The inference process runs a local reinforcement learning model, generates a plurality of training samples, and then adds the training samples to an external data storage area. The training process obtains the training samples from the data storage area, trains the local reinforcement learning model by using the training samples, and then sends an updated model weight parameter to the inference process. The inference process updates the local model by using the updated model weight parameter, and then continues to generate training samples by using an updated model. This implements parallel execution of the inference process and the training process. In addition, training samples can be generated and consumed in pipeline.

In this embodiment of this specification, the inference process and the training process are decoupled. Therefore, in the inference process, an acceleration solution that is specifically designed for the inference process and that cannot be applied to a training process can be used, for example, paged attention (paged attention), continuous batching (continuous batching), operator fusion (op fusion), etc. Applying these acceleration solutions in the inference process can greatly accelerate the inference process that accounts for 80% of an original consumed time. In addition, when a reasonable ratio between a quantity of inference processes and a quantity of training processes is set, the inference process and the training process can have no idle (idle) time to perform training of the reinforcement learning model with higher efficiency.

It should be noted that FIG. 2 shows merely an algorithm execution process and an interaction process between one inference process and one training process. In another embodiment, a plurality of inference processes and a plurality of training processes can alternatively be set. The plurality of inference processes each generate a training sample and add the training sample to the same data storage area. The plurality of training processes each train a local model, then perform weight parameter fusion on updated weight parameters, and update a model in each inference process based on a fused weight.

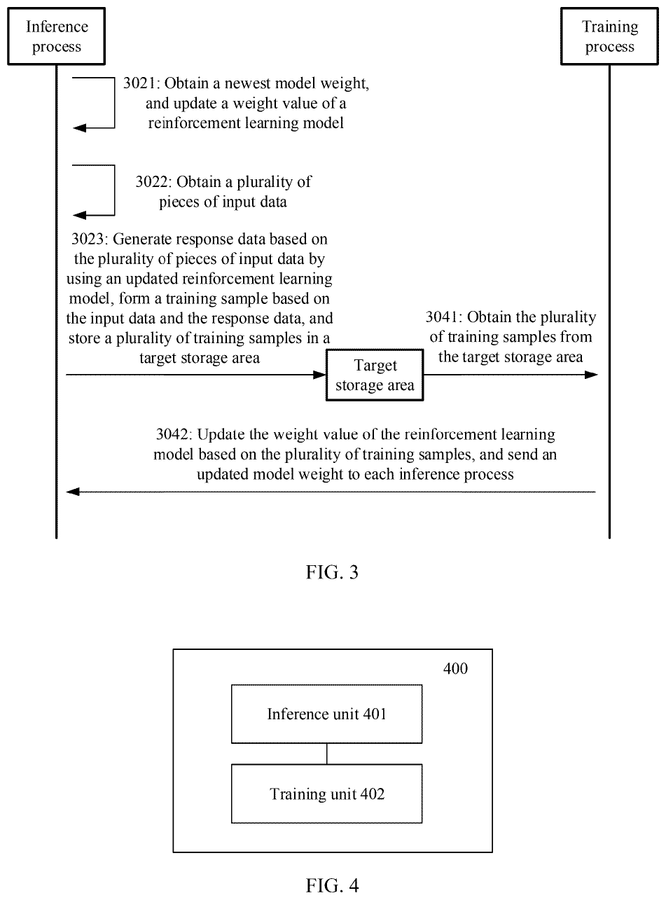

With reference to a specific embodiment, the following describes specific implementation steps of the above-mentioned reinforcement learning model training method. FIG. 3 is a flowchart illustrating a reinforcement learning model training method, according to an embodiment. The method is applied to a model training system. The model training system includes at least one training process and at least one inference process. The method can be executed by any platform, server, device cluster, etc. having computing and processing capabilities. As shown in FIG. 3, the method at least includes: Step 3021: Any inference process obtains a latest model weight, and updates a weight value of a reinforcement learning model. Step 3022: The inference process obtains a plurality of pieces of input data. Step 3023: The inference process generates response data based on the plurality of pieces of input data by using an updated reinforcement learning model, forms a training sample based on the input data and the response data, and stores a plurality of training samples in a target storage area. Step 3041: Any training process obtains the plurality of training samples from the target storage area. Step 3042: The training process updates a weight value of the reinforcement learning model based on the plurality of training samples, and sends an updated model weight to each inference process.

The following describes specific execution processes of the above-mentioned steps.

First, in step 3021, any inference process in the model training system obtains the latest model weight, and updates the weight value of the reinforcement learning model.

When the model training system runs in a first round, that is, the training process has not trained an initial reinforcement learning model, that the inference process obtains the latest model weight can be that the inference process reads a stored model weight from an external memory (for example, a hard disk), or directly reads a model weight initialized by the system.

When the training process has trained a local reinforcement learning model, that the inference process obtains the latest model weight can be that the inference process receives an updated model weight transmitted from the training process, and then updates a weight value of the local reinforcement learning model.

Then, in step 3022, the plurality of pieces of input data are obtained.

The input data can be training data in a training set trained in advance. The inference process reads a plurality of pieces of training data from the training set as the input data of the local reinforcement learning model.

Next, in step 3023, the response data is generated based on the plurality of pieces of input data by using the updated reinforcement learning model, the training sample is formed based on the input data and the response data, and the plurality of training samples are stored in the target storage area.

During reinforcement learning, the input data can be, for example, status data s, and the response data can be, for example, an action a made by an intelligent agent based on a status. In some embodiments, reward data r of an environment for the action and a new state s′ of the environment after the action a acts on the environment can be further obtained. As such, a training sample is formed and can be represented in a quadruple form (s, a, r, s′).

In some possible implementations, the reinforcement learning model is a reinforcement learning from human feedback RLHF model, and includes an action model and an evaluation model. In this case, the input data in step 3022 can be a prompt word. The action model can be a first large language model that outputs corresponding response data (response) based on an input prompt word. The evaluation model can be a second large language model that outputs, based on an input text sequence, a scalar value that is referred to as an evaluation value (value).

On this basis, step 3023 specifically includes: generating the response data based on the prompt word by using an updated action model; then, processing a spliced sequence (sequence) of the prompt word and the response data by using the evaluation model to generate an evaluation value (value); and next, generating a proximal policy optimization PPO sample as the training sample based on a PPO algorithm. The PPO sample at least includes the spliced sequence and the evaluation value.

Generating the PPO sample based on the action model, the evaluation model, and the prompt word by using the PPO algorithm is the conventional technology. Details are omitted here for simplicity. A form of a single PPO sample is a quintuple of “(sequence, action_logits, value, advantage, reward)”.

After generating the plurality of samples, the inference process stores the plurality of samples in the target storage area. The target storage area is a storage area that is independent of each inference process and each training process. Each inference process and each training process can access the target storage area.

In an embodiment, the target storage area can be implemented as a message queue (Message Queue).

Still with reference to FIG. 3, first, in step 3041, any training process in the model training system obtains the plurality of training samples from the target storage area.

In an implementation, the training sample is a quadruple in a form of (s, a, r, s′). In some possible implementations, the reinforcement learning model is a reinforcement learning from human feedback RLHF model, and the training sample is a PPO sample.

Then, in step 3042, the weight value of the reinforcement learning model is updated based on the plurality of training samples, and the updated model weight is sent to each inference process.

In an implementation, the reinforcement learning model is a deep Q-learning network DQN (Deep Q-learning Network). The reinforcement learning model includes a deep neural network for evaluating Q values, and policy logic for taking actions based on Q values, where the Q value represents a t-step long-term reward for an action. In this case, the training process updates the model weight of the deep neural network based on the training sample in the quadruple form of (s, a, r, s′).

In some possible implementations, the reinforcement learning model is an RLHF model, and specifically includes an action model and an evaluation model. The training sample is a PPO sample. Step 3042 specifically includes: training the action model and the evaluation model based on the PPO algorithm by using the PPO sample, updating the weight value in the model, and sending the updated model weight to each inference process.

The training process can send all weights of the model to the inference process. However, when a parameter of the model is at orders of magnitude of 1 billion, the training process sends all weights each time. A large amount of time and a large quantity of resources are occupied, thereby reducing overall training efficiency.

Therefore, in some embodiments, sending the updated model weight to each inference process in step 3042 includes: determining some target weight values that change after the reinforcement learning model is updated, and sending the target weight values to each inference process.

The training process sends only the changed weight values to each inference process so that an interaction speed can be improved and training efficiency can be further improved.

In some possible implementations, in a process of sending the weight values, to reduce model weight update overheads between the training process and the inference process, an RDMA (Remote Direct Memory Access, remote direct memory access) mechanism can be used so that the training process directly updates an updated model weight stored in a local display memory to a display memory address for storing a model weight in the inference process.

Specifically, the at least one training process includes a first training process that is allocated to a first display memory in a first GPU. The at least one inference process includes a first inference process that is allocated to a second display memory in a second GPU. The first display memory and the second display memory register with network hardware (for example, a network adapter supporting the function), so that the network hardware can directly access data in the first display memory and the second display memory. In this case, sending the updated model weight to each inference process in step 3042 includes:
sending a first command to the network hardware, where the first command includes a target memory address in the second display memory so that the network hardware sends the updated model weight stored in the first display memory to the second display memory to overwrite an existing model weight at the target memory address. In the above-mentioned process, intervention of a CPU is not needed to implement data transmission between different GPU display memories, thereby improving data transmission efficiency.

To further reduce network overheads, in some embodiments, the updated model weight can be stored in a continuous area in the first display memory. In this case, sending the first command to the network hardware includes: sending the single first command, where the target memory address is an address corresponding to the continuous area.

In this embodiment, weight sending and updating can be completed through only one time of communication.

Step 3021 to step 3023, and step 3041 and step 3042 shown in FIG. 3 do not have a specific execution sequence, and can be executed in any sequence or can be executed in parallel.

It should be noted that FIG. 3 shows merely an algorithm execution process and an interaction process between one inference process and one training process. In another embodiment, a plurality of inference processes and a plurality of training processes can alternatively be set. The plurality of inference processes each generate a training sample and add the training sample to the same data storage area. The plurality of training processes each train a local model, then perform weight parameter fusion on updated weight parameters, and update a model in each inference process based on a fused weight.

Specifically, in some possible implementations, when the at least one training process is a plurality of training processes, that any inference process obtains the latest model weight and updates the weight value of the reinforcement learning model in step 3021 includes that any inference process receives a plurality of latest model weights from the plurality of training processes, performs weight fusion on the plurality of weights, and updates the weight value of the reinforcement learning model based on a fused weight.

When a plurality of inference processes and a plurality of training processes are started for parallel computing, each inference process continuously generates new training samples, and each training process continuously consumes the training samples. If the plurality of inference processes generate samples at an excessively high speed, the inference processes pause further generating samples after generating a specified quantity of samples, and wait for the training processes to train reinforcement learning models and send most recent model weights. If the plurality of training processes consume samples at an excessively high speed, the training processes stop from time to time and wait for new samples to be generated. The above-mentioned two cases cause an idle (idle) state of a process, thereby causing an idle state of a computing resource.

Therefore, it is particularly important to set a reasonable ratio between a quantity of inference processes and a quantity of training processes. In some possible implementations, the ratio of the quantity of inference processes and the quantity of training processes in the model training system is determined in the following manner: determining a first quantity N₁ of training samples generated by a single inference process in a unit time; determining a second quantity N₂ of training samples used (consumed) by the single training process in the unit time; and determining a first ratio N₂/N₁ between the second quantity N₂ and the first quantity N₁ as the ratio of the quantity of inference processes and the quantity of training processes. In Formula (1):

$$\frac{{N}_{I}}{{N}_{T}} = \frac{{N}_{2}}{{N}_{1}} \qquad ( 1 )$$

N₁ is the quantity of inference processes, and N_{T} is the quantity of training processes.

In this embodiment of this specification, the inference process and the training process are decoupled, and are respectively executed by using different processes. Therefore, in some possible implementations, one or more inference acceleration solutions for accelerating a forward propagation process for inference are configured in the inference process. These inference acceleration solutions are designed specifically for the forward propagation process for inference, to greatly accelerate an inference speed. However, these solutions cannot be used in the training process. Thus, these inference acceleration solutions cannot be used in a solution without decoupling.

Specifically, the inference acceleration solution can at least include: paged attention, continuous batching, operator fusion, etc.

Paged attention is used to optimize computing of a self-attention layer. Since an attention score of each word (token) with each of all other words needs to be computed in self-attention, the computational complexity grows quadratically with the sequence length. A long sequence is divided into a plurality of pages (page) in paged attention. Intra-page attention is first computed, and then inter-page attention is computed, thereby greatly reducing a computing amount.

For continuous batching, conventionally, model inference is performed in a batch (batch) unit, and a next batch can be processed only after each batch is processed. Continuous batching is allowed to be performed in pipeline. When a current batch is not completed, a subsequent batch can be processed, thereby improving a degree of parallelism between batches.

For operator fusion, a neural network includes a large quantity of linear algebraic operations, for example, matrix multiplication and convolution. In an operator fusion technology, a plurality of small linear algebraic operations are combined into one large operation kernel (kernel), thereby reducing overheads of invoking a plurality of small kernels and improving performance.

In sum, in the reinforcement learning model training method proposed in this embodiment of this specification, the inference process and the training process are decoupled, and processing is performed by using different processes. Computing of the plurality of processes can be performed in parallel to improve an overall model training speed. In addition, the inference process can be accelerated by using a plurality of inference acceleration solutions, to greatly accelerate the inference process that originally occupies relatively high (for example, 80%) in a total duration. In addition, through setting the reasonable ratio between the quantity of inference processes and the quantity of training processes, there can be no idle time on both sides, thereby further improving efficiency of using a computing resource. In a weight transmission process, a GPU of one side directly accesses a display memory of the other side, thereby reducing CPU overheads for copying data and improving data transmission efficiency.

According to an embodiment in another aspect, a reinforcement learning model training apparatus is further provided. FIG. 4 is a schematic block diagram illustrating a reinforcement learning model training apparatus, according to an embodiment. The reinforcement learning model training apparatus is deployed in a model training system. The model training system includes at least one training process and at least one inference process. The apparatus can be deployed in any device, platform, or device cluster having computing and processing capabilities. As shown in FIG. 4, the apparatus 400 includes: an inference unit 401, configured to: obtain, by using any inference process, a latest model weight, and update a weight value of a reinforcement learning model; and generate response data based on input data by using an updated reinforcement learning model, form a training sample based on the input data and the response data, and store the training sample in a target storage area; and a training unit 402, configured to: obtain, by using any training process, the training sample from the target storage area; and update a weight value of the reinforcement learning model based on the training sample, and send an updated model weight to each inference process.

In some possible implementations, one or more inference acceleration solutions for accelerating a forward propagation process for inference are configured in the inference unit 401.

According to an embodiment in another aspect, a computer-readable storage medium is further provided. The computer-readable storage medium stores a computer program. When the computer program is executed in a computer, the computer is enabled to perform the method described in any above-mentioned embodiment.

According to an embodiment in still another aspect, a computing device is further provided, including a memory and a processor. The memory stores executable code. When executing the executable code, the processor implements the method described in any above-mentioned embodiment.

Embodiments in this specification are all described in a progressive manner. For same or similar parts in embodiments, refer to these embodiments. Each embodiment focuses on a difference from other embodiments. In particular, the apparatus embodiment is basically similar to the method embodiment, and therefore is described briefly. For related parts, references can be made to related descriptions in the method embodiment.

Specific embodiments of this specification are described above. Other embodiments fall within the scope of the appended claims. In some cases, the actions or steps described in the claims can be performed in an order different from that in embodiments, and the desired results can still be achieved. In addition, processes depicted in the accompanying drawings do not necessarily need a specific order or a sequential order shown to achieve the desired results. In some implementations, multi-tasking and concurrent processing are feasible or can be advantageous.

It should be noted that relational terms such as “first” and “second” are only adopted to distinguish one entity or operation from another entity or operation, and are not necessarily required or implied that there is any such actual relationship or order between these entities or operations. Moreover, the term “include”, “comprise”, or any other variant thereof is intended to cover non-exclusive inclusion, so that a process, a method, an article, or an apparatus that includes a series of elements includes not only those elements but also other elements that are not explicitly listed, or includes elements inherent to such a process, a method, an article, or an apparatus. Without further limitation, the element defined by the sentence “including a . . . ” does not exclude that other identical elements also exist in the process, method, article, or apparatus including.

A person of ordinary skill in the art can understand that all or some of the steps of the above-mentioned embodiments can be implemented by hardware or a program instructing related hardware program can be stored in a computer-readable storage medium. The above-mentioned storage medium can be a read-only memory, a magnetic disk, a compact disc, etc.

The above-mentioned specific implementations further describe in detail the objectives, technical solutions, and beneficial effects of this specification. It should be understood that the descriptions above are merely specific implementations of this specification, and are not intended to limit the protection scope of this specification. Any modifications, equivalent replacements, or improvements made without departing from the spirit and principle of this specification shall fall within the protection scope of this specification.

What is claimed is:

1. A method for reinforcement learning model training, wherein the method comprises:
in an inference process,
obtaining a latest model weight;
updating a weight value of a reinforcement learning model;
generating response data based on input data by using an updated reinforcement learning model
forming a training sample based on the input data and the response data; and
storing the training sample in a target storage area; and
in a training process,
obtaining the training sample from the target storage area;
updating the weight value of the reinforcement learning model based on the training sample; and
sending an updated model weight to the inference process.

2. The method according to claim 1, wherein the reinforcement learning model is a human feedback reinforcement learning model comprising an action model and an evaluation model, the input data is a prompt word, and the generating response data based on input data by using an updated reinforcement learning model, and forming a training sample based on the input data and the response data comprises:
generating the response data based on the prompt word by using an updated action model;
processing a spliced sequence of the prompt word and the response data by using the evaluation model, to generate an evaluation value; and
generating a proximal policy optimization (PPO) sample as the training sample, wherein the PPO sample comprises at least the spliced sequence and the evaluation value.

3. The method according to claim 1, wherein one or more inference acceleration solutions for accelerating a forward propagation process for inference are configured in the inference process.

4. The method according to claim 3, wherein the one or more inference acceleration solutions comprise at least paged attention, continuous batching, and operator fusion.

5. The method according to claim 1, wherein a ratio between a quantity of inference processes and a quantity of training processes is determined by:
determining a first quantity of training samples generated by a single inference process in a unit time;
determining a second quantity of training samples used by the single training process in the unit time; and
determining a first ratio between the second quantity and the first quantity as the ratio between the quantity of inference processes and the quantity of training processes.

6. The method according to claim 1, wherein the target storage area is implemented as a message queue.

7. The method according to claim 1, wherein the sending an updated model weight to the inference process comprises:
determining target weight values that change after the reinforcement learning model is updated; and
sending the target weight values to the inference process.

8. The method according to claim 1, wherein the method comprises at least one training process and at least one inference process, the at least one training process comprises a first training process that is allocated to a first display memory in a first graphics processing unit (GPU), the at least one inference process comprises a first inference process that is allocated to a second display memory in a second GPU, the first display memory and the second display memory register with network hardware, and the sending an updated model weight to the inference process comprises:
sending a first command to the network hardware, wherein the first command comprises a target memory address in the second display memory to indicate the network hardware to send the updated model weight stored in the first display memory to the second display memory to overwrite an existing model weight at the target memory address.

9. The method according to claim 8, wherein the updated model weight is stored in a continuous area in the first display memory; and the sending a first command to the network hardware comprises:
sending the first command, wherein the target memory address is an address corresponding to the continuous area.

10. The method according to claim 1, wherein the method comprises a plurality of training processes, and the obtaining a latest model weight, and updating a weight value of the reinforcement learning model comprises:
receiving a plurality of latest model weights from the plurality of training processes;
performing weight fusion on the plurality of latest model weights; and
updating the weight value of the reinforcement learning model based on a fused weight.

11. A non-transitory, computer-readable medium storing one or more instructions executable by a computer system to perform operations comprising:
in an inference process,
obtaining a latest model weight;
updating a weight value of a reinforcement learning model;
generating response data based on input data by using an updated reinforcement learning model
forming a training sample based on the input data and the response data; and
storing the training sample in a target storage area; and
in a training process,
obtaining the training sample from the target storage area;
updating the weight value of the reinforcement learning model based on the training sample; and
sending an updated model weight to the inference process.

12. The non-transitory, computer-readable medium according to claim 11, wherein the reinforcement learning model is a human feedback reinforcement learning model comprising an action model and an evaluation model, the input data is a prompt word, and the generating response data based on input data by using an updated reinforcement learning model, and forming a training sample based on the input data and the response data comprises:
generating the response data based on the prompt word by using an updated action model;
processing a spliced sequence of the prompt word and the response data by using the evaluation model, to generate an evaluation value; and
generating a proximal policy optimization (PPO) sample as the training sample, wherein the PPO sample comprises at least the spliced sequence and the evaluation value.

13. The non-transitory, computer-readable medium according to claim 11, wherein one or more inference acceleration solutions for accelerating a forward propagation process for inference are configured in the inference process.

14. The non-transitory, computer-readable medium according to claim 11, wherein a ratio between a quantity of inference processes and a quantity of training processes is determined by:
determining a first quantity of training samples generated by a single inference process in a unit time;
determining a second quantity of training samples used by the single training process in the unit time; and
determining a first ratio between the second quantity and the first quantity as the ratio between the quantity of inference processes and the quantity of training processes.

15. The non-transitory, computer-readable medium according to claim 11, wherein the sending an updated model weight to the inference process comprises:
determining target weight values that change after the reinforcement learning model is updated; and
sending the target weight values to the inference process.

16. The non-transitory, computer-readable medium according to claim 11, wherein the operations comprise at least one training process and at least one inference process, the at least one training process comprises a first training process that is allocated to a first display memory in a first graphics processing unit (GPU), the at least one inference process comprises a first inference process that is allocated to a second display memory in a second GPU, the first display memory and the second display memory register with network hardware, and the sending an updated model weight to the inference process comprises:
sending a first command to the network hardware, wherein the first command comprises a target memory address in the second display memory to indicate the network hardware to send the updated model weight stored in the first display memory to the second display memory to overwrite an existing model weight at the target memory address.

17. The non-transitory, computer-readable medium according to claim 11, wherein the operations comprise a plurality of training processes, and the obtaining a latest model weight, and updating a weight value of the reinforcement learning model comprises:
receiving a plurality of latest model weights from the plurality of training processes;
performing weight fusion on the plurality of latest model weights; and
updating the weight value of the reinforcement learning model based on a fused weight.

18. A computer-implemented device, comprising:
one or more processors; and
one or more tangible, non-transitory, machine-readable media storing one or more instructions that, when executed by the one or more processors, perform one or more operations comprising:
in an inference process,
obtaining a latest model weight;
updating a weight value of a reinforcement learning model;
generating response data based on input data by using an updated reinforcement learning model
forming a training sample based on the input data and the response data; and
storing the training sample in a target storage area; and
in a training process,
obtaining the training sample from the target storage area;
updating the weight value of the reinforcement learning model based on the training sample; and
sending an updated model weight to the inference process.

19. The computer-implemented device according to claim 18, wherein the reinforcement learning model is a human feedback reinforcement learning model comprising an action model and an evaluation model, the input data is a prompt word, and the generating response data based on input data by using an updated reinforcement learning model, and forming a training sample based on the input data and the response data comprises:
generating the response data based on the prompt word by using an updated action model;
processing a spliced sequence of the prompt word and the response data by using the evaluation model, to generate an evaluation value; and
generating a proximal policy optimization (PPO) sample as the training sample, wherein the PPO sample comprises at least the spliced sequence and the evaluation value.

20. The computer-implemented device according to claim 18, wherein the one or more operations comprise a plurality of training processes, and the obtaining a latest model weight, and updating a weight value of the reinforcement learning model comprises:
receiving a plurality of latest model weights from the plurality of training processes;
performing weight fusion on the plurality of latest model weights; and
updating the weight value of the reinforcement learning model based on a fused weight.
